(19) United States
(12) Patent Application Publication
(10) Pub. No.: US 2008/0080041 A1
(43) Pub. Date: Apr. 3, 2008

(54) Flat panel display

(75) Inventors: Tae-suh Park, Yongin-si (KR); Young-hyun Kim, Suwon-si (KR); Hee-seob Ryu, Suwon-si (KR); Yong-beom Lee, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/896,768

(22) Filed: Sep. 5, 2007

(30) Foreign Application Priority Data
Oct. 2, 2006 (KR) 10-2006-0097336

(51) Int. Cl. G02F 1/153

(52) U.S. Cl. 359/267

(57) ABSTRACT

Provided is a flat panel display (FPD), and more particularly, an FPD to display an image by controlling optical properties of a portion of the FPD. The FPD may include an image panel unit whose optical properties are locally controlled; a panel control unit to form a line field by controlling optical properties of a horizontal or vertical line region of the image panel unit; and an image input unit to project an image, which is to be output on the image panel unit, to the formed line field.

### CROSS-REFERENCE TO RELATED APPLICATIONS

This application claims priority benefit from Korean Patent Application No. 10-2006-0097336 filed on Oct. 2, 2006 in the Korean Intellectual Property Office, the disclosure of which is incorporated herein by reference in its entirety.

### BACKGROUND

1. Field

Embodiments relate to flat panel display (FPD), and more particularly, to an FPD displaying an image by controlling optical properties of a portion of the FPD.

2. Description of the Related Art

Conventional displays may be classified into cathode ray tubes (CRTs), flat panel displays (FPDs), and projection displays.

A CRT includes an electronic gun generating an electronic beam, a deflection yoke refracting the electronic beam in a desired direction of a screen to allow the electronic beam to collide with phosphors, and a mask preventing blurring in color. CRTs draw a pixel by activating phosphors on a screen by controlling the direction of emitted electrons through the deflection yoke. Due to such characteristics, it is difficult to make a large and flat display using CRT.

Generally, FPDs include liquid crystal displays (LCDs), plasma display panels (PDPs), and organic light-emitting displays (OLEDs). LCDs or PDPs are the most widely used among the FPDs. But because of its structural characteristics, the LCDs or PDPs require an expensive and complicated process for securing a production yield, especially when the display size increases.

In case of an LCD, as its size becomes larger, it shows problems in brightness uniformity and panel cost because of the change in back light units (BLUDs). In case of PDPs, as their screens become larger, the display becomes heavier, consumes more power, and emits more heat.

Owing to the customers' preference and the development of enabling technologies, flat panel displays has become a mainstream in display market. Accordingly, continuous attempts have been made in order to implement thinner and larger displays having relatively simple structures.

### SUMMARY

In an aspect of embodiments, there is provided a display having a structure in which an image is formed on a thin flat medium and thus capable of easily accommodating a thin and large screen.

In an aspect of embodiments, there is provided an image panel unit whose optical properties are locally controlled; a panel control unit to form a line field by controlling optical properties of a horizontal or vertical line region of the image panel unit; and an image input unit to project an image, which is to be output on the image panel unit, to the formed line field.

In an aspect of embodiments, there is provided a method for projecting an image on a flat panel display (FPD) including forming a line field by locally controlling optical properties of a horizontal or vertical line region of an image panel unit having chromic material; and projecting an image to the formed line field so that the image is output on the image panel unit.

### BRIEF DESCRIPTION OF THE DRAWINGS

These and/or other aspects, features, and advantages will become apparent and more readily appreciated from the following description of the embodiments, taken in conjunction with the accompanying drawings of which:

FIG. 1 is a block diagram of a flat panel display (FPD) according to an exemplary embodiment;

FIG. 2 is a perspective view of an image panel unit of the FPD according to an exemplary embodiment;

FIGS. 3A and 3B illustrate a principle of forming an image on the image panel unit;

FIGS. 4A and 4B illustrate a process of forming a line field using an electric field in an FPD according to an exemplary embodiment;

FIG. 5 illustrates a process of forming a line field using an electric field in an FPD that contains tungsten oxide according to an exemplary embodiment;

FIGS. 6A and 6B illustrate a process of forming a line field using an ultrasonic wave in an FPD according to an exemplary embodiment;

FIGS. 7A and 7B illustrate a process of forming a line field using heat in an FPD according to an exemplary embodiment;

FIGS. 8A and 8B illustrate a process of projecting an image to a line field from a laser source in an FPD according to an exemplary embodiment;

FIG. 9A illustrates a process of projecting an image to a line field using a plurality of micro-mirrors;

FIG. 9B illustrates a process of projecting an image to a line field using a rotating mirror or a rotating lens; and

FIGS. 10A and 10B illustrate a method of outputting an image on a screen of an FPD according to an exemplary embodiment.

### DETAILED DESCRIPTION OF EMBODIMENTS

Reference will now be made in detail to exemplary embodiments, examples of which are illustrated in the accompanying drawings, wherein like reference numerals refer to the like elements throughout. Exemplary embodiments are described below by referring to the figures.

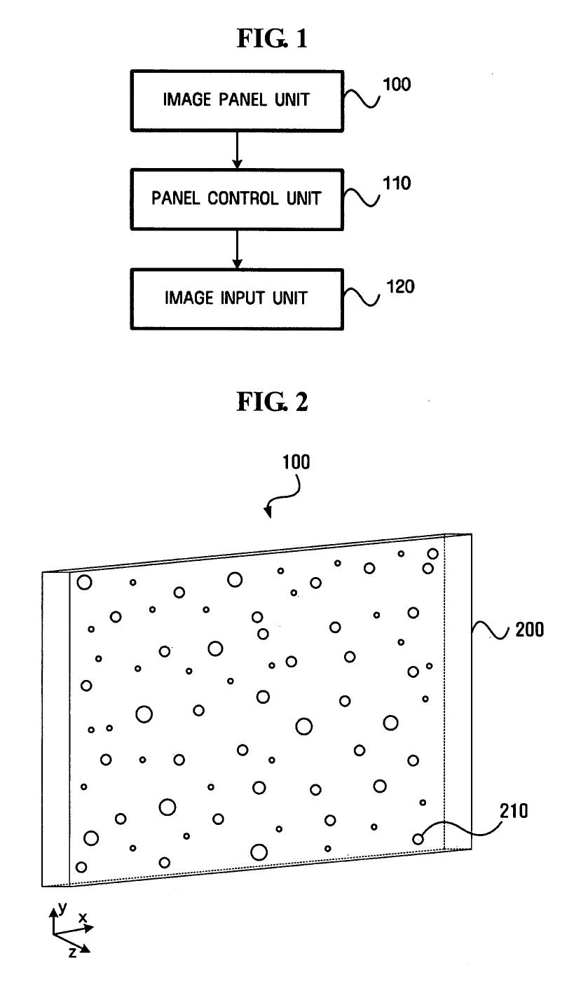

FIG. 1 is a block diagram of a flat panel display (FPD) according to an exemplary embodiment. FIG. 2 is a perspective view of an image panel unit 100 of the FPD according to an exemplary embodiment.

Referring to FIG. 1, the FPD includes the image panel unit 100, a panel control unit 110, and an image input unit 120.

The image panel unit 100 functions as a panel displaying an image. Optical properties of the image panel unit 100 can be changed locally. A flat panel 200 supporting the panel of the image panel unit 100 may be a substrate formed of glass or polymer. The flat panel 200 may include a chromic material 210 whose optical properties can be changed by an electric field, a magnetic field, light, an ultrasonic wave, or heat. As illustrated in FIG. 2, the chromic material 210 may be spread inside the flat panel 200 or deposited on a surface of the flat panel 200 as a thin film.

The image panel unit 100 having the chromic material 210 may be transparent even if light of a visible-light region passes therethrough. Even if the light of the visible-light region is irradiated to the chromic material 210, the weak diffusion or reflection of the light may occur. However, the optical properties of the image panel unit 100 having the chromic material 210 remain basically unchanged. Therefore, the image panel unit 100 appears transparent. Since the optical properties of the image panel unit 100 are hardly changed locally, even if light is irradiated onto the image panel unit 100, an image is not formed on the image panel unit 100.

The chromic material 210 may be added when the flat panel 200 is molded so that the chromic material 210 can be relatively uniformly spread inside or on the surface thereof. The chromic material 210 is formed of a material whose optical characteristics, such as transmittance, reflectance, and refraction in a visible light range, may be selectively changed by electric and magnetic fields. When the chromic material 210 is relatively uniformly spread inside or on the surface of the image panel unit 100, if an electric field, a magnetic field, an ultrasonic wave or heat is locally applied to the image panel unit 100, the optical properties of the image panel unit 100 are changed along a horizontal line at a particular height. Accordingly, the image panel unit 100 may have a thin band-shaped diffusion surface on which an image projected from under the image panel unit 100 can be formed.

A major example of the chromic material 210 includes an electrochromic material. A color change of the electrochromic material usually occurs between a transparent state and a colored state or between two colored states. In an exemplary embodiment, it may be assumed that the color change of the electrochromic material occurs between the transparent state and the colored state. Examples of the electrochromic material include tungsten trioxide (WO3) and vanadium tungsten oxide. Since tungsten trioxide and vanadium tungsten oxide can control the transmittance of visible light by combining with positive ions (mainly, H+ or Li+) which are induced by an electric field, they can selectively enter the transparent state or an opaque state according to the presence of the electric field. Due to such properties, tungsten trioxide and vanadium tungsten oxide have been commercially used for energy-saving windows called “smart windows.” Film-type transition metal oxide (TMO), such as iridium, rhodium, ruthenium, manganese or cobalt, may also be used as the electrochromic material.

In addition to inorganic materials of the tungsten oxide group, conducting polymers have recently been used as new electrochromic materials. The conducting polymers are generated by chemical/electrical polymerization reaction of organic aromatic molecules such as pyrrole, anilin, thiophene, furan and carbazole. The conducting polymers may be designed to have different optical properties when in an oxidation state and in a reduction state. Compared with the inorganic materials described above, the conducting polymers can be processed to a desired form more easily. Furthermore, the color of the conducting polymers can be adjusted by modifying the structure of a main chain and its pendent group. For example, polyisothianaphtalene (PITN) is a transparent conducting polymer-based electrochromic material. PITN shows a distinct reversible color change between the transparent state and the colored state and has excellent stability.

Another example of the electrochromic material may be o-Chloranil (o-CA). Due to electrical/chemical reduction, a blue thin film is formed on an electrode. If the thin film is oxidized, the color of the thin film tends to disappear. Conducting polymers, which have rather low transmittance of white light but can have various color changes, such as polypyrrole (Ppy), polyanilin (PANI), polythiophene, and poly o-amino phenol (PAP), may also be used.

A thermochromic material may also be used as the chromic material 210. For example, a refractive index of a material for an optical switch using perfluorinated acrylate varies according to temperature changes. Therefore, the optical properties can be controlled.

The panel control unit 110 changes the optical properties of the image panel unit 200 locally. The panel control unit 110 applies an electric field, heat, or an ultrasonic wave to a portion of the image panel unit 100, thereby changing a refractive index or transmittance of a horizontal line of the image panel unit 200 or diffusing light source.

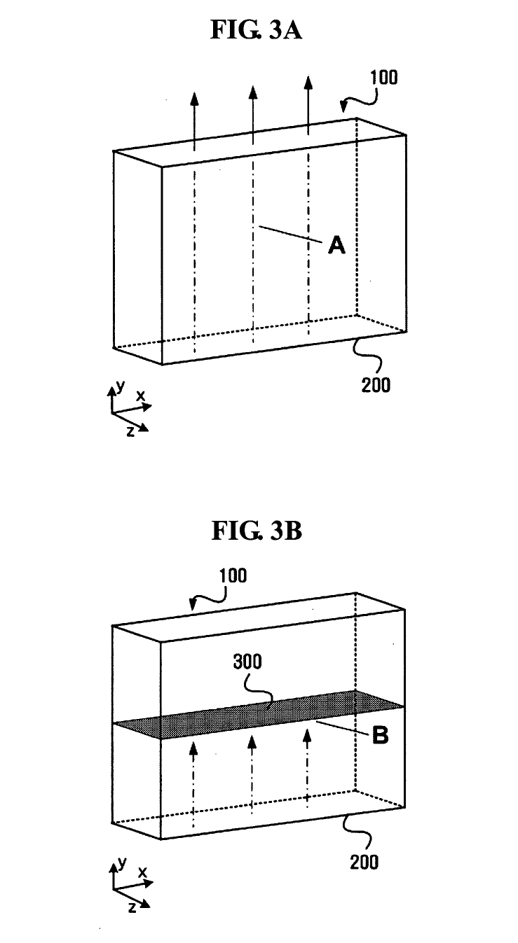

FIGS. 3A and 3B illustrate the principle of forming an image on the image panel unit 200.

The principle of forming an image on the image panel unit 200 will now be briefly described with reference to FIGS. 3A and 3B. Light is visible to the human eye when it is reflected directly by a light source or an object and reaches the retina of the human eye. Therefore, light vertically emitted from a light source under the image panel unit 100 as illustrated in FIG. 3A is hardly diffused or reflected while passing through the image panel unit 100. As a result, an observer can see nothing at a location A. Since there is virtually no difference in the refractive index or transmittance of the light within the image panel unit 100, no optical path for directing the light from the light source to the observer is formed. Therefore, the light, which is passing through the image panel unit 100, travels straight ahead.

If an electric field, an ultrasonic wave, or heat is horizontally applied to the image panel unit 100 from a predetermined height of the image panel unit 100, the optical properties of the chromic material 210 are changed. If a line field 300 formed of the chromic material 210 with the changed optical properties is generated as illustrated in FIG. 3B, light emitted from under the image panel unit 100 is diffusely reflected or specularly reflected by the line field 300. Consequently, an optical path is formed at a location B, and an observer can see a row of an image, which is projected from the light source, formed at location B of the image panel unit 100.

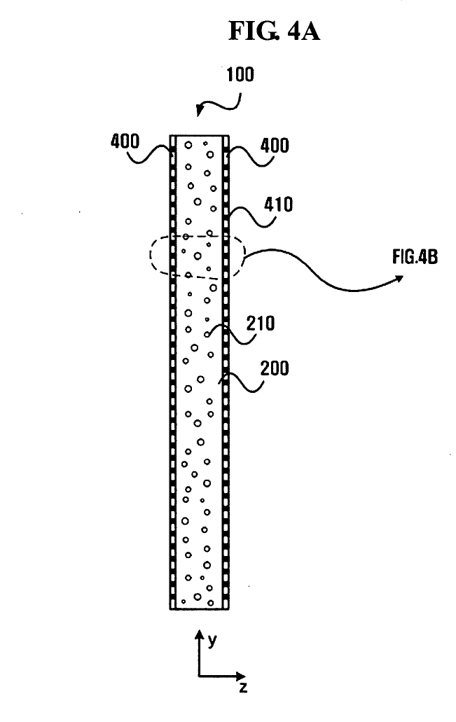

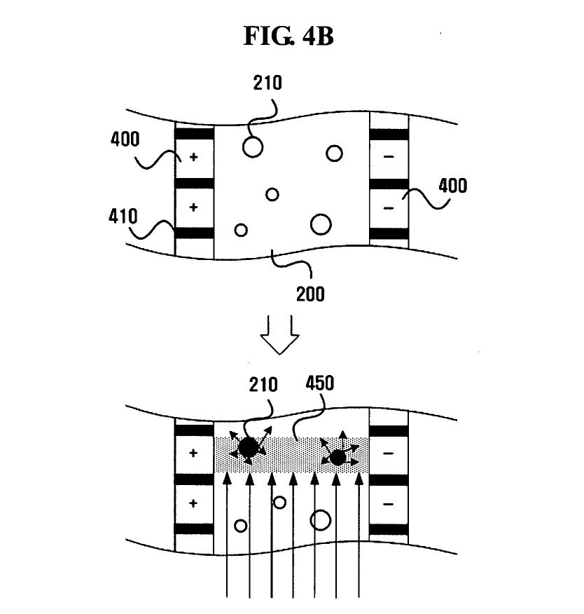

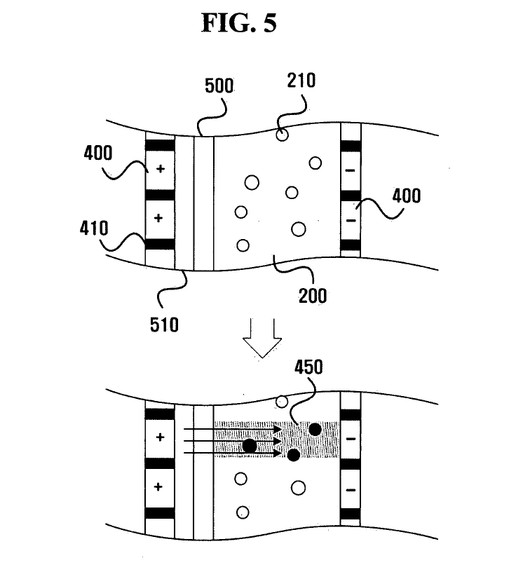

FIGS. 4A and 4B illustrate a process of forming a line field using an electric field in an FPD according to an exemplary embodiment. FIG. 5 illustrates a process of forming a line field using an electric field in an FPD that contains tungsten oxide according to an exemplary embodiment.

Referring to FIG. 4A, a panel control unit 110 may generate an electric field in units of rows in a thickness (z-axis direction) of an image panel unit 100 and form a line field composed of a chromic material 210 whose optical properties in a region where the electric field is generated are noticeably different from those in other regions. The image panel unit 100 includes a flat panel 200 having the chromic material 210 spread and a transparent electrode 400 deposited on a surface of the flat panel 200. The electrode 400 may be a conventional transparent indium tin oxide (ITO) electrode and thus coated on surfaces on both sides of the flat panel 200. In addition, an insulation layer 410 may be formed between lines in order to apply the electric field at a predetermined height.

FIG. 4B illustrates optical properties changed by an electric field as an example.

Before an electric field is applied to the flat panel 200 having the chromic material 210, the flat panel 200 is transparent. Therefore, light can pass through the flat panel 200. However, when the electric field is applied to a predetermined line of the flat panel 200, if the chromic material 210 contained in the line is a conducting polymer, the composition and structure of molecules are changed. Therefore, there occurs a difference in refractive index or transmittance between the line to which the electric field is applied and regions excluding the line. Due to such changes, the line can function as a screen.

Referring to FIG. 5, an image panel unit 100 may include a flat panel 200 containing a chromic material 210, an ion storing film 510, an electrolyte layer 500, and an electrode 400. Since the flat panel 200 contains the chromic material 210, its optical properties may be locally changed by an electric field 450. The ion storing film 510 stores ions so that the ions can be supplied to the flat panel 200 by the electric field 450. The electrolyte layer 500 induces the ions to pass therethrough. The electrode 400 forms a film which can apply the electric field 450 to the flat panel 200 in a thickness direction of the flat panel 200 so that the ions can move in the thickness direction. In order to apply the electric field 450 to a line at a predetermined height, an insulation layer 410 may be formed at regular intervals.

As illustrated in FIG. 5, when voltage is applied to the electrode 400, a potential difference is created in the thickness direction of the flat panel 200. The potential difference causes the ions stored in the ion storing film 510 to jump out toward a negative electrode. While moving toward the negative electrode, the ions are combined with the chromic material 210, thereby changing the structure of the chromic material 210. If the chromic material 210 is tungsten trioxide, it permeates an interstitial site within a tungsten oxide cube by cathodic polarization which causes ion insertion and electron injection using an electric field. Consequently, the tungsten trioxide changes into opaque tungsten bronze having different optical properties from those of the original tungsten trioxide. If the optical properties, in particular, transmittance, of the chromic material 210 are changed locally, a band-shaped line field containing the changed chromic material 210 functions as a screen that diffuses incident light.

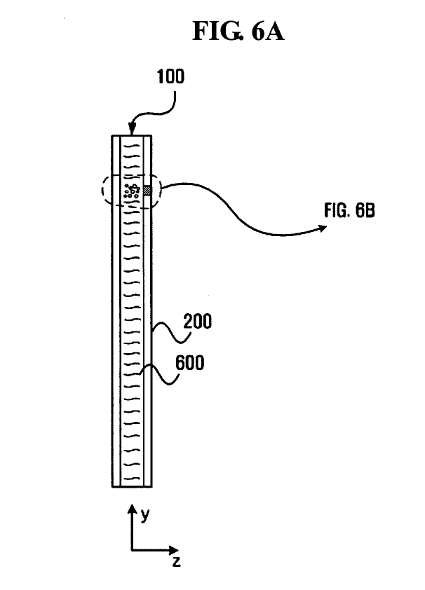

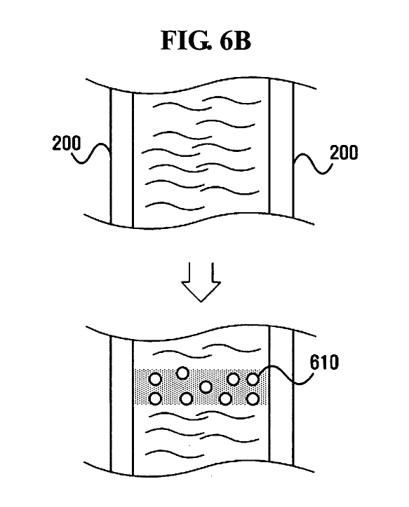

FIGS. 6A and 6B illustrate a process of forming a line field using an ultrasonic wave in an FPD according to an exemplary embodiment.

Referring to FIGS. 6A and 6B, an image panel unit 100 is structured to insert a fluid 600 between two flat panels 200 under high pressure in order to form a line field using an ultrasonic wave. After the fluid 600 is inserted between the flat panels 200, if the fluid 600 is vibrated using the ultrasonic wave, tiny cavitation 610 may be generated in the fluid 600. Since the refractive index of light at the generated cavitation 610 and its neighboring boundaries is significantly changed in all directions, light incident to a surface of each cavitation 610 is diffused. Consequently, a line field having the generated cavitation 610 functions as a band-shaped screen on which an image is formed. An ultrasonic wave is applied to the image panel unit 100 using an ultrasonic wave generator from a left or right side of the image panel unit 100 in a direction in which a line field is desired to be formed. In order to enhance linearity of the ultrasonic wave, a plurality of ultrasonic waves may be simultaneously applied to the image panel unit 100. The ultrasonic waves may cause a constructive interference to occur at a location where a line field is formed, thereby inducing resonance. In addition, the ultrasonic waves may cause a destructive interference to occur outside the line field so that an image is formed only in a corresponding line. If the projection of the ultrasonic wave is stopped, the generated cavitation 600 can be almost immediately removed under high pressure.

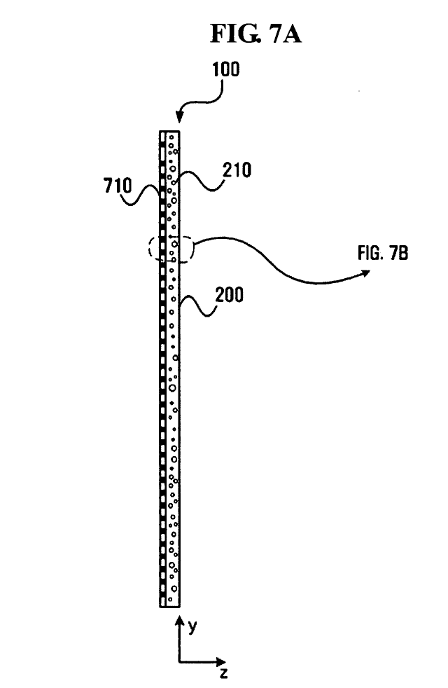

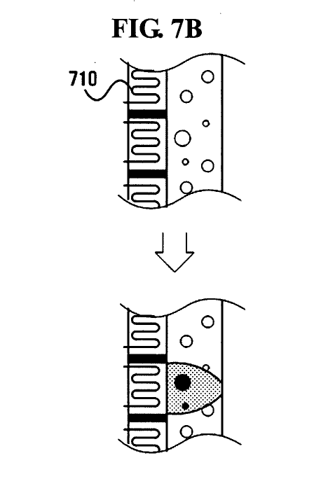

FIGS. 7A and 7B illustrate a process of forming a line field using heat in an FPD according to an exemplary embodiment.

Referring to FIGS. 7A and 7B, a heat wire 710 is horizontally attached in each line on a rear surface of a flat panel 200. Therefore, if a line field is to be activated, the heat wire 710 of a corresponding line can be heated. If a thermochromic material is used as a chromic material 210, the heat generated by the heated heat wire 710 can change the optical properties of the chromic material 210 of the line.

As described above, the panel control unit 110 can locally change the optical properties of the chromic material 210 using the electric field, ultrasonic wave and or heat, thereby forming the line field 300 to display an image. After the line field 300 on which an image is to be displayed is formed, a source having the image can be projected to the line field 300.

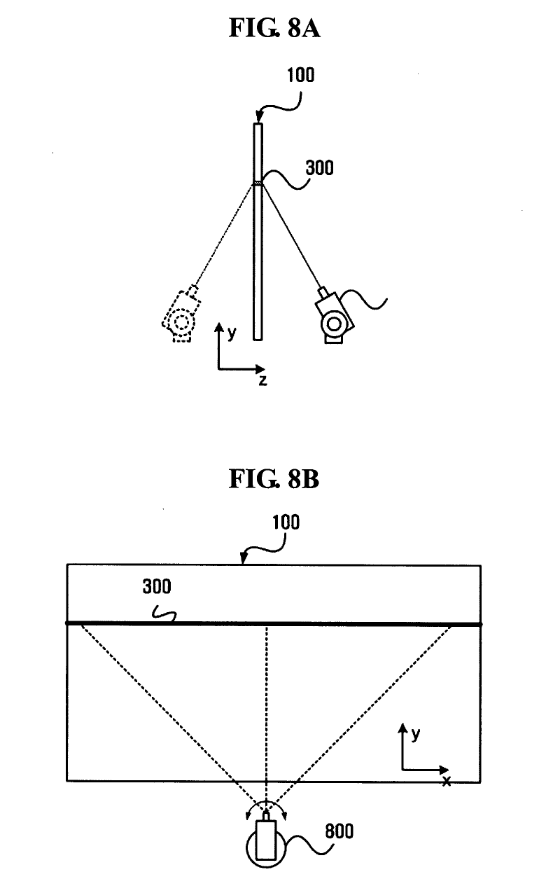

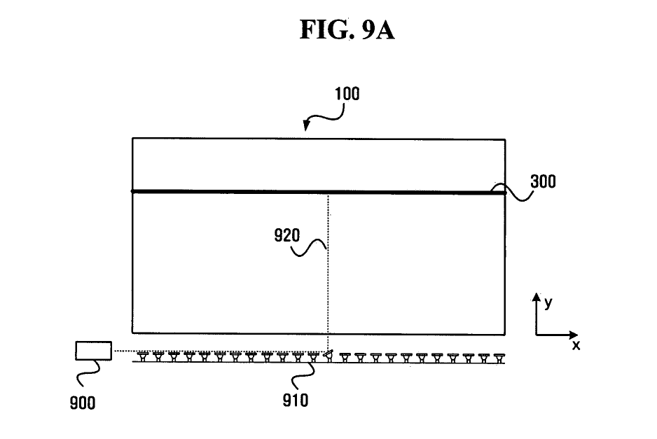

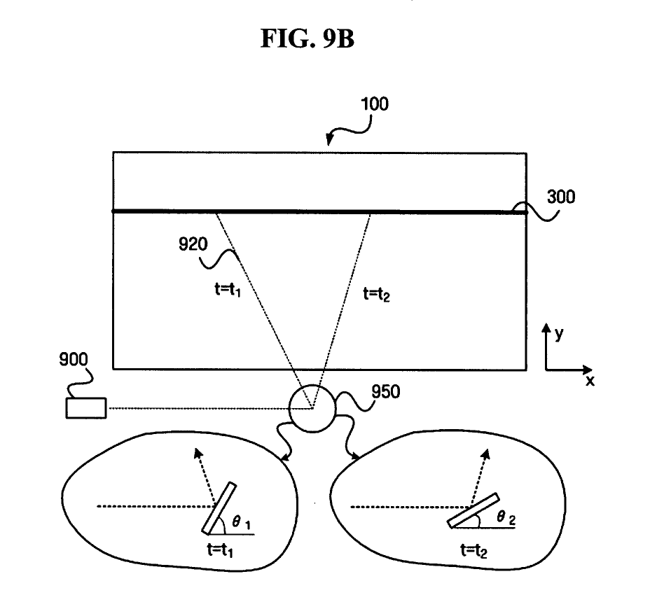

FIGS. 8A and 8B illustrate a process of projecting an image to a line field from a laser source in an FPD according to an exemplary embodiment. FIGS. 9A and 9B illustrate a process of projecting an image to a line field using a micro-mirror, a rotating mirror, or a rotating lens.

An image input unit 120 projects an image signal that is to be output on a screen to a line field 300. If a panel control unit 110 forms the line field 300 at a height at which an image is to be displayed, the image input unit 120 projects the image to the line field 300 so that an observer can see the image formed in a corresponding line.

Referring to FIG. 8A, an image may be projected from a light source having high linearity, such as a laser source 800, to a line field 300. The laser source 800 may be disposed in front of or behind the image panel unit 100. Alternatively, the laser source 800 may be disposed under or above the image panel unit 100 and vertically project an image.

Referring to FIG. 8B, the laser source 800 may project an image to the line field 300 by rotating to the right or left. Alternatively, a light source may be projected in the form of a line field at one time.

In order to project an image to a line field, a path of the image can be adjusted using a plurality of micro-mirrors, a rotating mirror, or a rotating lens illustrated in FIGS. 9A and 9B. Since an image signal is output for each line, an image input unit 120 sequentially projects horizontal scan line information, which is image information of each line, into an image panel unit 100.

An image input unit 120 may include a light source 900 and a light control unit 910 or 950.

The light source 900 transmits an image signal that is to be output on the image panel unit 100. The light source 900 may project visible light through an appropriate optical system to have sufficient linearity or use a laser having superior linearity.

The light control unit 910 or 950 creates an optical path directing light emitted from the light source 900 into the image panel unit 100. The light control unit 910 or 950 properly positions the light emitted from the light source 900 in a line field, on which an image is formed using the light source 900, according to a pixel

Referring to FIG. 9A, the optical control unit 910 may be a plurality of micro-mirrors. A method of operating the micro-mirrors to form light emitted from the light source 900 on a pixel at x=960 and y=540 in an image composed of 1920×1080 pixels will now be described as an example. Before a pixel at x=1 and y=540 is projected, an image control unit locally changes the optical properties of a chromic material of the image panel unit 100 at a height of y=540, thereby forming a line field 300. Immediately before light containing an image signal of the pixel at x=960 and y=540 is transmitted by the light source 900, a 960^{th} micro-mirror rises and creates a vertical optical path. Therefore, light whose path has been changed proceeds toward a 960^{th} pixel in an x direction, and light proceeding upward reaches and is diffused by a 540^{th} line field, which was already formed. Consequently, an image of the pixel at x=960 and y=540 in the entire image is formed at a corresponding position, and an observer can see the image.

As described above, after a line field is formed, the micro-mirrors can be controlled at high speed to change an optical path so that an image can be formed in each pixel in a horizontal axis (x-axis). A technology of controlling a plurality of micro-mirrors at high speed is already an established field in the field of, for example, digital light processing (DLP) projectors. Therefore, a detailed description of the technology will be omitted.

Referring to FIG. 9B, the image input unit 120 includes the light source 900 and the light control unit 950. The optical control unit 950 may be a rotating mirror or lens. While rotating at high speed, the rotating mirror projects an image output from the light source 900 to pixels on an x axis. In other words, while rotating, the rotating mirror varies an angle of reflection of the light, thereby projecting the light to first through last pixels. Similarly, an image can be projected to the pixels on the x axis by changing a path of light using a combination of lenses. Since an angle of rotation of the rotating mirror and a corresponding displacement in the x-axis direction are changed according to a y-axis value, the angle of reflection of the rotating mirror or lens may be changed accordingly.

In another exemplary embodiment, an image input unit may be disposed under an image panel unit and include a plurality of light sources projecting images to pixels on the x axis, respectively. In this case, each of the light sources may be implemented as a laser having superior linearity in order to prevent an optical interference.

The operation of the FPD configured will now be described.

The optical properties of a portion of the FPD on which an image is to be formed are changed using the panel control unit 110, thereby forming a line field. In order to locally change the optical properties of the FPD, an electric field, an ultrasonic wave or heat may be applied to a corresponding line.

As described above, if a line field having optical properties changed by the panel control unit 110 is formed in each line, an image corresponding to each line is output. Then, another line field is formed in a next line, and an image corresponding to the next line is also output.

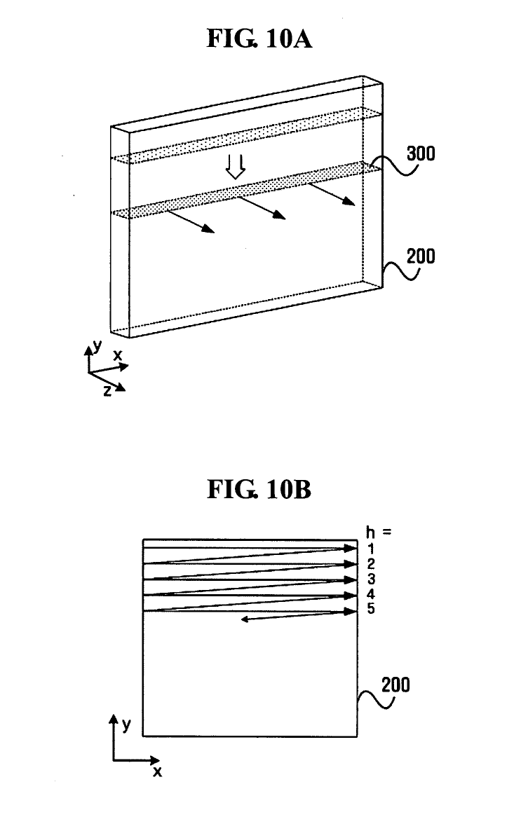

FIGS. 10A and 10B illustrate a method of outputting an image on a screen of an FPD according to an exemplary embodiment. If an image signal is processed using, for example, a Raster scan method, an H_sync signal is used as a line field generation signal as illustrated in FIG. 10B. In response to the H_sync signal, line fields are generated sequentially from a first (h=1) line at the top to a last (h=n) line at the bottom of a flat panel 200. Immediately after each line field is formed, an image input unit projects an pixel image for each pixel of a corresponding line field so that an image can be formed in the line field (see FIG. 10A). If images of the first through last lines are output, an output image can be completed. After a screen is scanned, a panel control unit may remove all remaining line fields in response to a V-sync signal, thereby rendering an image panel unit transparent.

The above process may be repeated in order to scan a next screen. A method of scanning a screen described above is the Raster scan method in which horizontal-axis lines are output from the top to bottom. However, in an exemplary embodiment, after vertical-axis line fields are formed, an image may be projected to the vertical-axis line fields. Then, the image may be output on a screen as the vertical-axis line fields are scanned in the horizontal direction.

As described above, exemplary embodiments provide at least one of the following advantages.

First, a display having a structure in which an image is formed on a thin flat medium and thus capable of easily accommodating a thin and large screen can be implemented.

Second, an electric field, an ultrasonic wave, or heat is locally applied to change optical properties of the portion, thereby enhancing energy efficiency.

Third, since a simplified structure in which an image is formed on a thin medium is used instead of a pixel-by-pixel operation system as in LCDs or PDPs, an inexpensive display can be implemented.

Although a few exemplary embodiments have been shown and described, it would be appreciated by those skilled in the art that changes may be made in these exemplary embodiments, the scope of which is defined in the claims and their equivalents.

What is claimed is:

1. A flat panel display (FPD) comprising:
an image panel unit whose optical properties are locally controlled;
a panel control unit to form a line field by controlling optical properties of a horizontal or vertical line region of the image panel unit; and
an image input unit to project an image, which is to be output on the image panel unit, to the formed line field.

2. The FPD of claim 1, wherein the image panel unit comprises a flat panel having a chromic material, whose optical properties are controllable by an electric field or heat, and wherein the chromic material is spread inside of the flat panel or on a surface of the flat panel.

3. The FPD of claim 2, wherein the panel control unit forms the line field by changing the optical properties of the chromic material included in line region of the image panel unit by applying the electric field or heat to the line region.

4. The FPD of claim 1, wherein the optical properties are optical transmittance or a refractive index.

5. The FPD of claim 1, wherein the panel control unit and the image input unit, are operated one after the other, to project the image by drawing horizontal pixel lines from top to bottom.

6. The FPD of claim 1, wherein the panel control unit forms the line field, by applying the electric field which is generated by the potential difference between two sides along thickness direction of the image panel unit, at a predetermined height of the image panel unit.

7. The FPD of claim 6, wherein the image panel unit comprises:
a flat panel having a chromic material spread inside of the flat panel or on a surface of the flat panel; and
an electrode to generate the electric field in the flat panel.

8. The FPD of claim 7, wherein the electrode is insulated row by row in order to generate the electric field as horizontal line-shaped at the predetermined height.

9. The FPD of claim 6, wherein the image panel unit comprises:
a flat panel having a chromic material spread inside of the flat panel or on a surface of the flat panel;
an electrolyte layer to provide a path for ions moving from one side to the other side of the flat panel;
an ion source film to provide the ions; and
an electrode to generate the electric field to move the ions.

10. The FPD of claim 9, wherein the chromic material is tungsten trioxide (WO3), vanadium tungsten oxide, or a conducting polymer.

11. The FPD of claim 1, wherein the image panel unit comprises:
two transparent flat panels; and
a transparent fluid layer between the two transparent flat panels.

12. The FPD of claim 11, wherein the panel control unit generates the line field, which consists of cavitation bubbles, in the transparent fluid layer by transmitting ultrasonic wave in horizontal direction from a side of the image panel unit.

13. The FPD of claim 11, wherein the panel control unit controls a constructive interference to occur in the region at a predetermined height and a destructive interference to occur in other regions using a plurality of ultrasonic waves.

14. The FPD of claim 1, wherein the panel control unit applies heat to the image panel unit at a predetermined height of the image panel unit and thus forms the line field.

15. The FPD of claim 1, wherein the image panel unit comprises:
a flat panel having a chromic material, whose optical properties are controllable by heat, wherein the chromic material is spread inside of the flat panel or on a surface of the flat panel; and
a heat wire horizontally, which is attached on a rear surface of the flat panel, to heat the chromic material at a predetermined height of the flat panel.

16. The FPD of claim 1, wherein the image input unit projects the image to the line field using a laser source.

17. The FPD of claim 16, wherein the image panel unit comprises a flat panel, wherein the laser source is disposed in front of the flat panel, behind the flat panel, above the flat panel, or under the flat panel and wherein the laser source projects the image to the line field.

18. The FPD of claim 1, wherein the image input unit comprises:
a light source to project an image; and
a light control unit to control a path of the image projected by the light source to direct the image to the line field.

19. The FPD of claim 18, wherein the light control unit comprises a plurality of micro-mirrors to vertically redirect the image, which is projected by the light source, in order to direct the image to the line field.

20. The FPD of claim 18, wherein the light control unit comprises a rotating mirror or a rotating lens to direct the image, which is projected by the light source, to the line field by changing an angle of reflection of the image.

21. A method for projecting an image on a flat panel display (FPD) comprising:
forming a line field by locally controlling optical properties of a horizontal or vertical line region of an image panel unit having chromic material; and
projecting an image to the formed line field so that the image is output on the image panel unit.
